(19) United States
(12) Patent Application Publication
(10) Pub. No.: US 2024/0284903 A1
(43) Pub. Date: Aug. 29, 2024

(54) BIOMIMETIC NACRE-LIKE MATERIAL FOR RECRUITMENT AND GROWTH OF OYSTER SPAT

(71) Applicant: Christopher Joseph Karwacki, Churchville, MD (US)

(72) Inventor: Christopher Joseph Karwacki, Churchville, MD (US)

(21) Appl. No.: 18/543,970

(22) Filed: Dec. 18, 2023

Related U.S. Application Data
(60) Provisional application No. 63/487,591, filed on Feb. 28, 2023.

(51) Int. Cl. A01N 25/26; A01N 25/10; A01N 59/00; A01P 19/00; E02B 3/04

(52) U.S. Cl. CPC A01N 25/26; A01N 25/10; A01N 59/00; A01P 19/00; E02B 3/046

(57) ABSTRACT

Materials composed of inorganic and organic compounds that inhibit, promote and stabilize nanostructured crystalline calcium carbonate for the recruitment and growth of oyster larvae and spat. By using simple chemical precursors in a bottom-up or top-down approach, a variety of layered material compositions can be obtained which result in a standalone material or one that can be applied to and supported by cementitious substrates. The chemical compounds and processes described in this invention are scalable, thus providing for manufacturing small or large quantities of tailored materials, utilizing a variety of techniques, such as but not limited to 3-D printing, spraying, molding and freeze casting to produce a broad spectrum of material compositions and forms suitable for a variety of oyster species and estuarine environments.

### BACKGROUND OF THE INVENTION

### Field of the Invention

This invention relates to a solid material that provides important structural and chemical cueing properties of natural oyster shell for the recruitment and growth of oyster larvae and spat. As such these materials and the processes for preparation relate to the field of oyster aquaculture with the aim to enhance recruitment rates and to develop sustainable populations of live oysters.

### Description of the Background

Oysters with all their grand beauty and complexity serve a vital role in the health and diversity of estuaries where their impact can only be effective in large numbers. With oyster populations at a historical low and confronted with insurmountable factors such as overfishing, sedimentation and disease the resiliency of the present biomass is reputedly at a tenuous stage.

The decline of the oyster population has been observed for well over a century. Coupled with generations of anecdotal data and in recent decades science-based investigations, definitive empirical and stochastic trends have emerged. One prominent study (Powell et al. 2007) provides a holistic understanding of the unique dynamical relationship between natural and man-made factors effecting oyster survival and growth. A key outcome of this aggregated work is the strong dependence of shell mass on oyster recruitment rate and abundance across several dominant destabilizing factors, such as disease, natural mortality and fishing.

“Maintenance of an adequate recruitment rate is the single most profound response to the needs of the population and also the shell resource, because an increase in recruitment can substantively offset a larger increase in natural mortality.” (Powell et al. 2007)

In the recent decade the practice of incubating oyster larvae (Horn Point Oyster Hatchery, Cambridge, MD) to recruit oyster spat on recycled shell has provided a stabilizing resource for growth of oysters throughout the Chesapeake Bay region. Although the manufacturing process, growing oyster larvae and setting on recycled oyster shell, is scalable to accommodate increasing demand, the limiting factor is the availability of natural recycled oyster shell or alternative material. Compounded by an era of a burgeoning aquaculture industry, involving the growth and harvesting of natural oyster, there is a critical need for suitable cultch material, which can be used to form shell beds to promote efficient recruitment of oyster larvae and growth of spat throughout the oyster's life cycle to harvest.

For many years alternative cultch materials used for setting of live oyster larvae have been employed primarily based on the availability of solid substrates, such as recycled and fossilized oyster shell, clam and conch shell, limestone, granite, new and recycled concrete, and porcelain (Goelz et al. 2020). The demand for these materials tends to be regional and vary based on the availability of sufficient quantities of natural recycled shell and alternatively non-oyster shell substrates. For example, prior art by Quayle, Garvey, Orteg and Lawrence show a variety of material compositions such as cement based mixtures containing asbestos, coal fly-ash, agricultural products and other compound additives with the aim to provide oyster cultch materials. Although these materials have been met with mixed results and others with alarming toxicological consequences, the fact remains that there is a lack of suitable oyster cultch material that mimics the properties of natural oyster shell that can meet the needs of the aquaculture industry. Given the magnitude of the problem and the interplay of demands that are emerging, there is a need for material-based solutions and best practices that hold promise for restoring oyster abundant populations towards historical levels.

### The State of Biomineralized Nacre.

There is no limit to the body of literature that discusses biomineralization of natural borne inorganic and organic species. For several decades, great effort has been spent toward understanding the chemical composition and growth mechanisms of exoskeleton species such as mollusks. The pursuit of this foundational knowledge is motivated by the desire to develop mineralized ceramic like materials for a wide range of material properties and applications, such as coatings and structures for electronics, optics, ballistic protection, medical devices and solar energy (Aizenberg, 2002, Cusack et al., 2008, Xu et al. 2018).

A specific interest is one directed to a biomimetic nacre-like composition, which mimics natural biomineralized materials that is characterized by a variety of mollusk environments, chemistries, composition and structure (Zeng, 2018, Jacob 2008). With advances in surface sensitive instrumentation, such as advanced cryo-electron microscopy, electron diffraction and scanning tunneling microscopy, detailed images at the atomic and molecular scale are being pursued to understand composition, structure and growth mechanisms of exoskeletons. What is generally accepted today is that biomineralization mechanisms of mollusks are highly complex and unique to individual species and environments for which they survive. Given the advances in understanding the property-activity relationships of biomineralized materials, biomimetic pathways have yet to be realized that accurately mimic the chemical and structural complexity of natural borne assemblies (Finnemore et al. 2012). A similar state of the art is observed in photosynthesis where mimicking the chemistry and structural relationships can result in design rules for developing sun-activated materials for energy conversion.

### SUMMARY OF THE INVENTION

The present invention is directed to a bio-inspired approach that mimics the chemical and structural compositions that yields a nacre-like ceramic and that achieves a desired specification in property and performance. In other words, the present invention circumvents the natural bio-mechanism (natural biomineralization) using man-made processes. More specifically, given the complexity of the biomineralized process of a natural oyster nacre shell, there is presented here a highly selective and repeatable process for developing the layered structure which results in a hierarchical and intercalated structure comprising crystalline calcium carbonate as aragonite and calcite, organic binders for strengthening, and organic macromolecules for encapsulation.

The present invention is particularly suited for the manufacture of synthetic oyster shell that possesses important cueing properties for oyster larvae, recruitment and growth of spat and the maturation of live oysters.

### General Applications and Potential Uses of Materials:

Shell-like material (composite) for developing cultch beds and reef-like structures to provide for setting (attachment) and recruitment (growth) of oyster spat.

Accordingly, there is provided according to the invention a method for the manufacture of synthetic oyster shell material comprising the steps:
a. preparing solubilized (non-crystalline) amorphous calcium carbonate by mixing a calcium hydroxide with carbonic acid and carbon dioxide;
b. adding an organic acid binder and inorganic inhibitor to the amorphous calcium carbonate solution to promote, nucleation, growth and stabilization of a crystalline aragonite-calcium carbonate and inhibit the formation and concentration of calcite-calcium carbonate;
c. applying an organic macromolecule to the crystalline aragonite-calcium carbonate.

According to various embodiments of the invention the carbon dioxide and carbonic acid may be present in a ratio of at least about 2:1. Higher ratios will increase the rate of calcium carbonate formation. Preferred ratios are 10:1 and 15:1, but even higher ratios will perform well. An inorganic inhibitor, preferably magnesium ion (Mg²⁺) or similar divalent ion, for example Ca²⁺, may optionally be added in step b. to further inhibit formation of calcite-calcium carbonate. The inorganic inhibitor may optionally be added to the amorphous calcium carbonate solution at molar ratios of magnesium ion to calcium ion ranging from 0.1 to 2.5, preferably 0.5 to 1.5, and most preferably at about 1.0. The organic binder is added to the amorphous calcium carbonate solution may optionally be added at a concentration of 0.5% to 5% by weight of calcium carbonate, preferably 1% to 5%, and most preferably 3%. The organic binder preferably is an amino acid and/or carboxylic acid. The organic macromolecule may be a functionalized cellulose-like compound, for example, chitin, acetates, or similar polymeric compounds having oxygen, an amide and a hydroxyl group. The organic macromolecule is added to the calcium carbonate layer at 0.5% to 5%, preferably 1% to 3% and most preferably 1% by weight of calcium carbonate. According to a preferred embodiment, application of the organic macromolecule takes place immediately following formation of the crystalline calcium carbonate. According to further preferred embodiments, steps a., b., and c. form a first layer, and then are repeated to form successive layers.

There is further provided according to the invention a composition comprising:
a. a first layer of aragonite-calcium carbonate encapsulated in or coated with an organic macromolecule;
b. at least one subsequent layer of aragonite calcium carbonate encapsulated in or coated with an organic macromolecule located adjacent said first layer; and
c. a cementitious core substrate for binding and support of the first and subsequent layers of aragonite calcium carbonate, organic binder, and encapsulated macromolecule;

There is further provided according to the invention a second method for the manufacture of synthetic oyster shell material comprising the steps:
a. preparing solubilized (non-crystalline) amorphous calcium carbonate by mixing a calcium hydroxide, with carbonic acid and carbon dioxide;
b. adding an organic acid binder and inorganic inhibitor to the amorphous calcium carbonate solution to promote, nucleation, growth and stabilization of a crystalline aragonite-calcium carbonate and inhibit the formation and concentration of calcite-calcium carbonate to produce a synthesized calcium carbonate composite;
c. preparing a second, preferably pre-existing or pre-formed, crystalline calcium carbonate material, which may be naturally-sourced, for example ground oyster shell, nacre or similar mollusk exoskeleton, or man-made, for example ground calcium carbonate of the calcite or aragonite crystalline form, in any case having a range of particle sizes and shapes, ranging from 50 to 5000 micron in size, preferably 100 micron to 1,000 micron, and most preferably 200 micron, the shapes preferably jagged and/or irregular shapes;
d. dispersing the pre-formed second calcium carbonate material and said synthesized calcium carbonate composite (the result of steps a and b) to a cementitious substrate, for example, a natural or man-made core structure, reef structure, a concrete slab or brick, or other three-dimensional structure that enhances efficient uptake and growth of oyster larvae.
e. applying an organic macromolecule to the dispersed said second calcium carbonate material and said synthesized crystalline calcium carbonate composite.

As with the first method embodiment described above, the carbon dioxide and carbonic acid may be present in a ratio of at least about 2:1. Higher ratios will increase the rate of calcium carbonate formation. Preferred ratios are 10:1 and 15:1, but even higher ratios will perform well. An inorganic inhibitor, preferably magnesium ion (Mg²⁺) or similar divalent ion, for example Ca²⁺, may optionally be added in step b. to further inhibit formation of calcite-calcium carbonate. The inorganic inhibitor may optionally be added to the amorphous calcium carbonate solution at molar ratios of magnesium ion to calcium ion ranging from 0.1 to 2.5, preferably 0.5 to 1.5, and most preferably at about 1.0. The organic binder is added to the amorphous calcium carbonate solution may optionally be added at a concentration of 0.5% to 5% by weight of calcium carbonate, preferably 1% to 5%, and most preferably 3%. The organic binder preferably is an amino acid and/or carboxylic acid. The organic macromolecule may be a functionalized cellulose-like compound, for example, chitin, acetates, or similar polymeric compounds having oxygen, an amide and a hydroxyl group. The organic macromolecule is added to the calcium carbonate layer at 0.5% to 5%, preferably 1% to 3% and most preferably 1% by weight of calcium carbonate. According to further preferred embodiments, steps a., b., c., d. and e. form a first layer, and steps a., b., c., d., and e. may be repeated to form successive layers.

### BRIEF DESCRIPTION OF THE DRAWINGS

The foregoing summary, as well as the following detailed description of the preferred invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a depiction of an overview of material composition and process according to an embodiment of the invention.

FIG. 2 is a Detailed View of Molecular Level Interaction and Binding of An Organic Acid and Inorganic Cation That Promotes Nucleation, Growth, Stabilization and Strengthening of Crystalline Aragonite Calcium Carbonate (a-CaCO3) according to an embodiment of the invention.

FIG. 3 is an illustration of the Macromolecular Layer Encapsulation of Core Layer Consisting of Crystalline Aragonite Calcium Carbonate (a-CaCO3) and Organic Binder according to an embodiment of the invention.

FIG. 4 is a Detailed View Showing the Biomimetic Material Consisting of the Macromolecular Layer Interaction with Core Layer Consisting of Crystalline Aragonite Calcium Carbonate (a-CaCO3) and Organic Binder according to an embodiment of the invention.

FIG. 5 is a Simplified Schematic Representation of the Biomimetic Material Consisting of the Macromolecular Layer Encapsulation of and Interaction with Core Layer Consisting of Crystalline Aragonite Calcium Carbonate (a-CaCO3) and Organic Binder of major components of the hierarchical biomimetic material according to an embodiment of the invention.

FIG. 6 is a Composite View of the Super Hierarchical Material Composed of Sequential Layers (Composite view depicting sequential layers of biomimetic nacre) according to an embodiment of the invention.

FIG. 7 is a Composite View of Sequential Layers of Biomimetic Mineralized Nacre Encapsulating A Cement Core and Coated Surface according to an embodiment of the invention.

FIG. 8 is a Composite View of Sequential Layers of Man-Made and Pre-formed Mineralized Nacre (calcium carbonate) and Encapsulating Macromolecule attached to a Cementitious Core according to an embodiment of the invention.

### DETAILED DESCRIPTION OF THE INVENTION

The current invention involves a solid composite material that mimics the structural and chemical cueing properties of natural oyster shell for the recruitment and growth of oyster larvae and spat. A chemical cue involves a reaction between two or more substances characterized by signaling and can have a major influence on habitat selection and growth. A chemical cue is particularly important in biological systems, such as with developing oyster larvae and their ability to attach to material surfaces that resembles their own chemical-structural properties. Chemical cues can also be influenced by the chemistry of the water such as pH (i.e., acidity and alkalinity) and chemical species (e.g., CO2, Ca, Mg, Fe, NaCl).

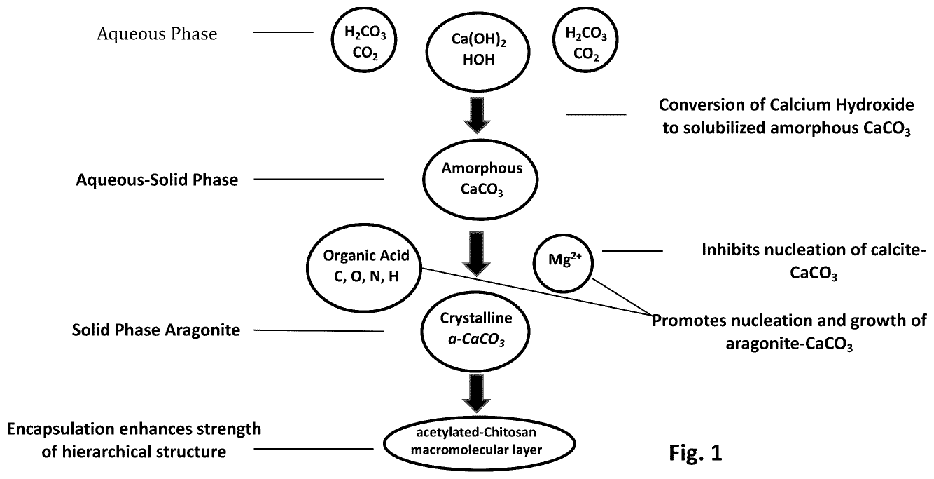

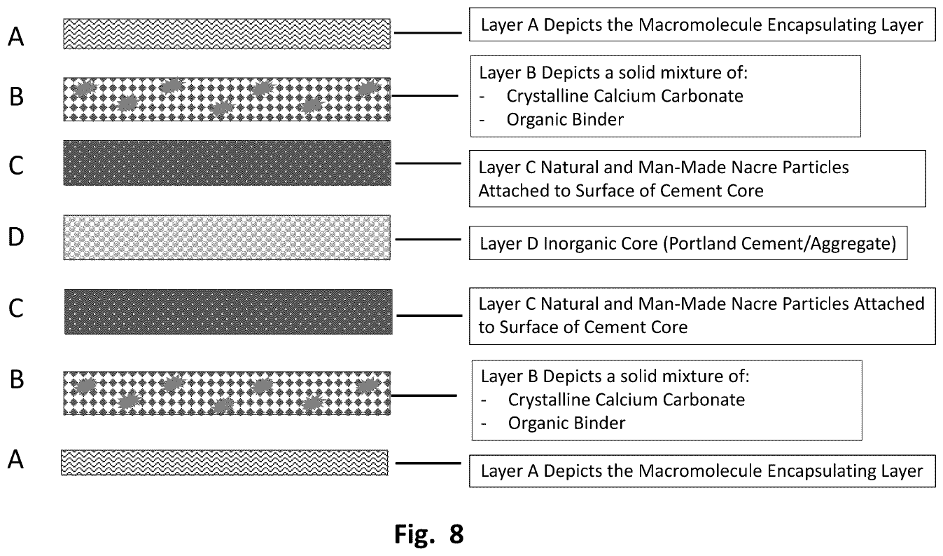

By using simple chemical precursors in a bottom-up approach (starting with the chemical synthesis of crystalline calcium carbonate) as shown in FIGS. 1-7 or a hybrid bottom-up and top-down approach (using oyster shell material or other pre-existing calcium carbonate-based material) as shown in FIG. 8, a variety of layered material compositions can be obtained which result in a standalone material or one that can be applied to and supported by cementitious substrates. The current material is composed of varying compositions of nanocrystalline particles containing aragonite and calcite calcium carbonate and organic compound binders containing a mixture of functional groups, such as carboxylic acids, amides and alcohols. An example of a low molecular weight compound is aspartic acid, which promotes nucleation of crystalline calcium carbonate and strengthening of the calcium carbonate matrix. An example of a high molecular weight (a macromolecule) compound is chitin, which encapsulates and bonds to the calcium carbonate-organic binder matrix, thus further strengthening the nacre shell material. Numerous chemical compounds and mixtures for binding and encapsulation can be used that vary in the number and type of chemical functional groups containing oxygen, amide and hydroxyl groups and their spatial arrangement within the molecule.

Referring to FIG. 1, the bottom-up process (starting with molecules and building a tailored bulk material) uses calcium hydroxide, water and carbonic acid, carbon dioxide gas to form an amorphous calcium carbonate (amorph-CaCO3) material. An organic acid binder is added to the mixture to convert amorphous calcium carbonate to crystalline calcium carbonate either in the calcite or aragonite form. The preferred form is aragonite, but the calcite form also works for the purpose of the invention. The ratio or relative concentration of aragonite calcium carbonate to calcite calcium carbonate can be adjusted by adding magnesium ion (Mg²⁺) to inhibit the formation of calcite nucleation and to promote the nucleation and formation of aragonite.

FIG. 1, Step 1: Conversion of Calcium Hydroxide to Amorphous Calcium Carbonate—Interaction of precursor calcium hydroxide and a mixture of carbonic acid and carbon dioxide mediate the formation of solubilized (non-crystalline) amorphous calcium carbonate (amorph-CaCO₃). Molar concentrations and pressures of carbonic acid and carbon dioxide may preferably be CO₂:Ca ratio of 2:1, but may be as high as approximately 10:1 or even 15:1 CO₂:Ca to ensure efficient availability, binding and reaction of carbon dioxide (CO₂) with calcium hydroxide.

FIG. 1, step 2: Nucleation of aragonite-Calcium Carbonate (a-CaCO₃)—An organic acid (C, O, N, H) binder with concentrations roughly ranging from 0.5 to 5 weight percent and divalent metal(s), preferably Mg²⁺ with molar ratios to calcium ion roughly ranging from 0.1 to 2.5, are added to the amorphous calcium carbonate (amorph-CaCO₃) solution to promote, nucleation, growth and stabilization of the preferred crystalline aragonite-calcium carbonate a-CaCO₃ and inhibit the formation and concentration of calcite-calcium carbonate (c-CaCO₃)

Preferred organic acid binders are those that contain amino and carboxylic acid groups in proximity to each other, such as aspartic acid, glutamic acid, carbamic acid and glycine or mixtures of similar low molecular weight organic compounds containing amino and carboxylic acid groups.

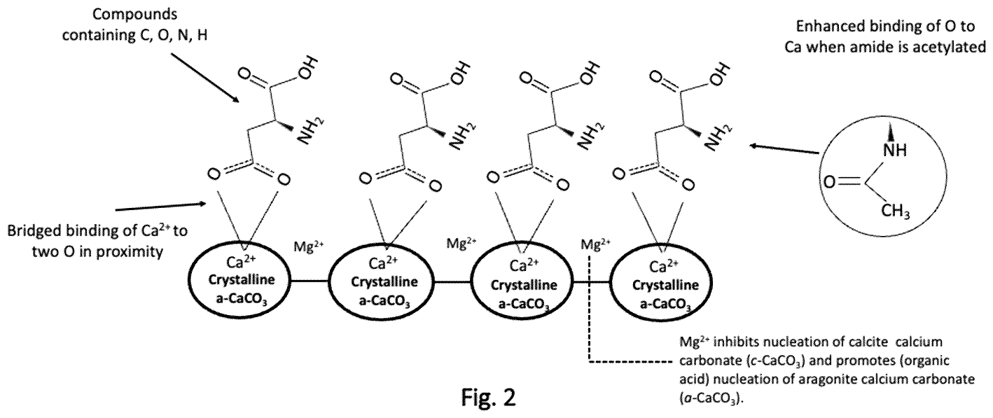

Further enhanced binding can result if divalent cations of Calcium (Ca⁺²) in the crystalline CaCO₂ can interact and bind with one or two double bonded oxygen atoms in proximity to neighboring nitrogen atoms of the organic acid binder. See, FIG. 2. The presence of Mg²⁺ cations (0.1 to 2.5 magnesium to calcium ratio) with organic acid binder (0.5 to 5 wt %) performs initially as an inhibitor towards the formation of calcite calcium carbonate (c-CaCO₃), which promotes the nucleation and growth of aragonite calcium carbonate (a-CaCO₃). Upon nucleation of the aragonite calcium carbonate, a spontaneous process occurs with growth of aragonite calcium carbonate (a-CaCO₃). Furthermore Mg²⁺ is excluded energetically from the crystalline calcium carbonate.

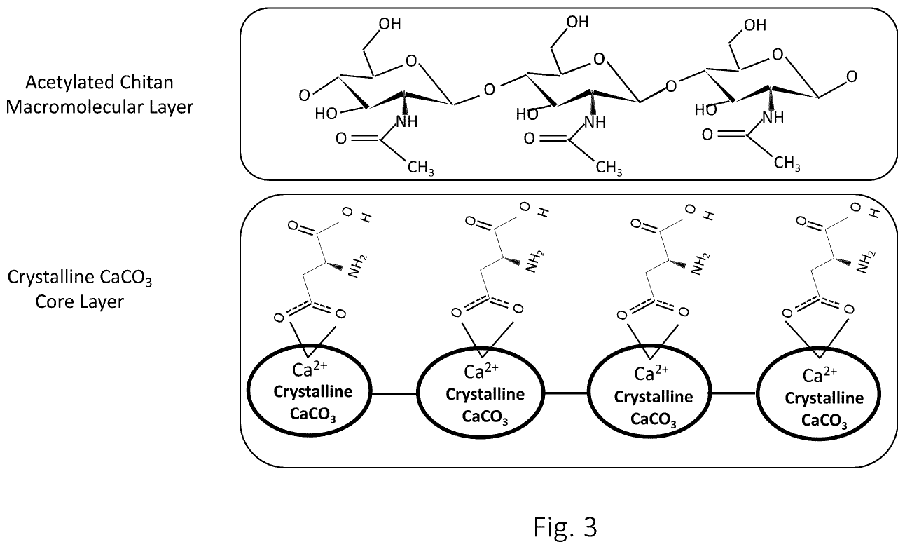

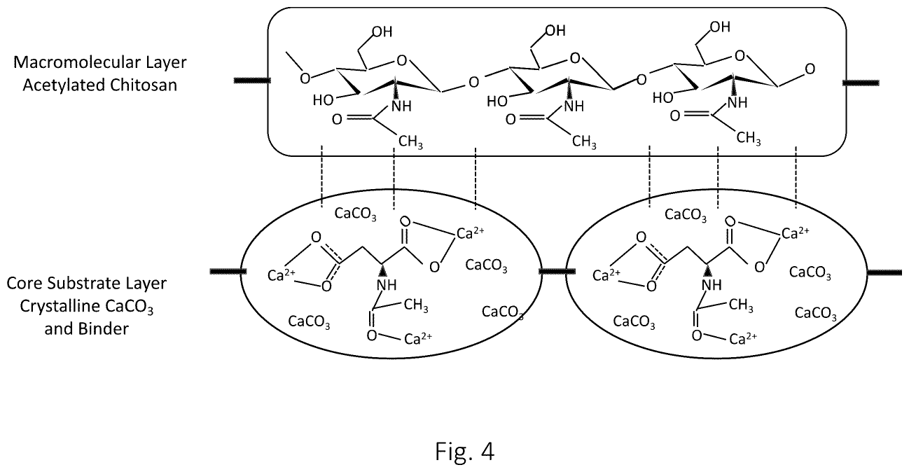

FIG. 1, step 3: Encapsulation of crystalline calcium carbonate with macromolecular compound-Following formation of crystalline calcium carbonate, an organic macromolecule having carbon, oxygen, nitrogen and hydrogen groups is applied to the a-CaCO₃ core-layer at 0.5 to 3 wt % to encapsulate the calcium carbonate matrix and provide enhanced stability and strengthening of the composite; see FIGS. 3 and 4. Preferably, the macromolecule may be a functionalized cellulose compound that contains amide and acetyl groups that can vary in molecular weight and the number density of amide-acetyl groups. Examples include chitin, and similar polymeric acetates. This class of materials can optionally be obtained from natural sources such as crab and shrimp carapaces or from synthetically derived (man-made) cellulose diacetate and triacetate. The macromolecule is preferably added as a post-treatment step immediately following the formation of the transition phase from modified amorphous calcium carbonate to crystalline calcium carbonate. This matrix consisting of the modified calcium carbonate and the macromolecule constitutes a single hierarchical layer.

FIG. 4 shows a more detailed scheme depicting the interaction of the macromolecule with the surface of the calcium carbonate matrix. As noted, the preferred macromolecular compound is naturally sourced chitin, for example from crabs and shrimp carapace, or acetylated chitosan or similar synthetic functionalized cellulose or man-made acetate compounds.

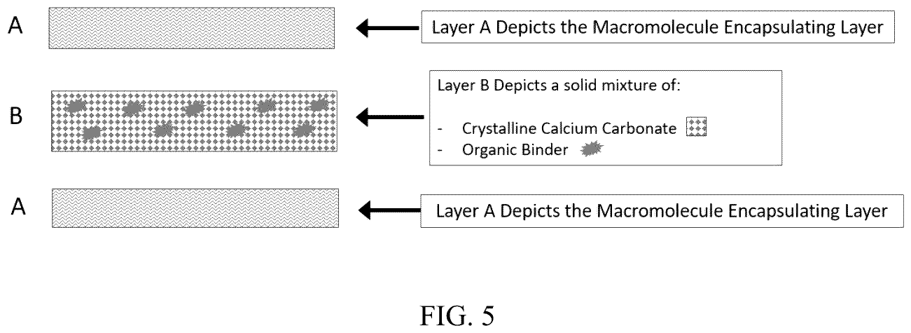

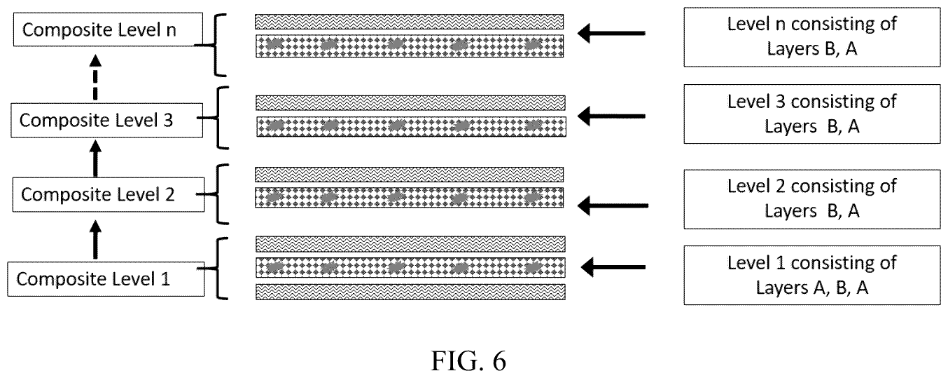

FIG. 5 depicts a first embodiment of the invention in which a single layer of crystalline calcium carbonate (Layer B) is encapsulated by the macromolecular encapsulating layer (Layers A). By building upon the basic hierarchical structure (unit structure) shown in FIG. 5, additional sets of B/A layers can be sequentially laid down upon the basic and initial layers A/B/A using a layer-by-layer assembly, as shown in FIG. 6, to achieve a composite periodic structure with a desired set of properties, such as thickness and strength.

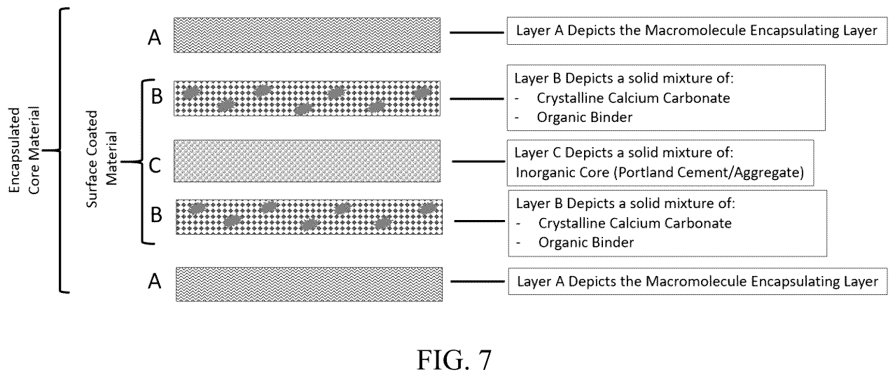

According to an alternative embodiment, shown in FIG. 7, layer B may first be attached to/used to coat a cementitious core C, which crystalline calcium carbonate-coated cementitious core is then encapsulated by the macromolecule encapsulating material resulting in the following layered assembly:
Layer A Macromolecule Encapsulating Layer (For Stabilization And Strengthening)
Layer B Organic Promoter/Accelerant Layer, For Binding Of/Crystallization To Calcium Carbonate)
Layer C Cement Core As Substrate Support For Biomimetic Nacre Composite Material
Layer B Organic Promoter/Accelerant Layer, For Binding Of/Crystallization To Calcium Carbonate)
Layer A Macromolecule Encapsulating Layer (For Stabilization And Strengthening)

One example of a scalable manufacturing process that depicts use of the chemical constituents described in FIGS. 1-6, a bottom-up approach, consists of a mixture of calcium hydroxide water and carbonic acid/carbon dioxide to form the amorphous calcium carbonate. The initial compound can be adjusted to a desired viscous mixture that can be further combined with organic binder and magnesium ion to promote the formation of crystalline calcium carbonate. The combined aggregate after thorough blending can be dispersed by but not limited to 3-D printing or spray techniques over a range of temperature and relative humidity to form thin sheets of approximately 0.1 to 2 mm thickness. The single layer material proceeds to undergo a phase transition from calcium hydroxide to amorphous calcium carbonate (amorph-CaCO₃) to crystalline aragonite calcium carbonate (a-CO₃) and calcite calcium carbonate (c-CaCO₃). During the drying phase the macromolecule can be applied by 3-D printing or spray techniques onto the newly formed core layer of binder-infused calcium carbonate, thus further enhancing the stability and strength of the single layered composite. The comprised layer can be cut and shaped to a desired form and subsequent layers can be added with compositions described above to build a structure of desired thickness to typically but not limited to 3-10 mm.

An alternative composite as described in FIG. 7 employs a similar composition and manufacturing process as described above where the aggregate layers of newly formed calcium carbonate are applied to and chemically bound to a core layer of cementitious substrate. In this manufacturing process the cementitious substrate of desired strength and density is initially formed in 2-D or 3-D structures. During the initial set-up and solidification period thin layers of calcium hydroxide aggregate (consisting of calcium hydroxide, carbonic acid/carbon dioxide, water, organic binder and magnesium ion) are applied by 3-D printing or spraying techniques, followed by encapsulation using the macromolecule. The process is repeated to build layers of fortified calcium carbonate.

Where the embodiments described above (FIGS. 1-7) relate to a “bottom up” approach where a calcium carbonate-based or artificial “nacre” is synthesized from basic chemicals such as calcium hydroxide, bicarbonate/carbon dioxide, organic binder and magnesium, another embodiment, represented in FIG. 8, is a hybrid composition consisting of a “bottom up” and “top-down” approach. Here the embodiments described above (FIGS. 1-7) are further enhanced by the addition of pulverized natural oyster shell particles (nacre, conch or similar mollusk exoskeleton), and/or other pre-existing natural or man-made calcium carbonate-based particles (such as ground calcite road salt, for example), and a macromolecule for encapsulation attached to a cementitious core:
Layer A. Macromolecule Encapsulating Layer
Layer B Organic Promoter/Accelerant Layer, For Binding Of/Crystallization To Calcium Carbonate)
Layer D. Natural and/or Man-Made calcium-carbonate-based Particles Attached To Surface Of Cement Core
Layer C. Cement Core As Substrate Support For Natural Nacre Particles
Layer D. Natural and/or Man-Made calcium-carbonate-based Particles Attached To Surface Of Cement Core
Layer B Organic Promoter/Accelerant Layer, For Binding Of/Crystallization To Calcium Carbonate)
Layer A. Macromolecule Encapsulating Layer

Further, an alternative composite as described in FIG. 8, (a hybrid bottom-up and top-down approach) employs a composition of preformed natural, man-made and synthesized calcium carbonate that is applied and chemically bound to a cementitious substrate. In this manufacturing process selected preformed natural, man-made calcium carbonate, in aragonite and/or calcite form, may be sieved to desired particle sizes ranging from about 50 to 5000 microns and preferably having or including jagged and/or irregular shape which are then dispersed and bound onto the wet cement substrate. A macromolecule substrate may be applied by but not limited to 3-D printing and spray techniques to stabilize and strengthen the aggregate composition.

It will be appreciated by those skilled in the art that changes could be made to the preferred embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A method for the manufacture of synthetic oyster shell material comprising the steps:
a. Preparing solubilized (non-crystalline) amorphous calcium carbonate by mixing a calcium hydroxide with carbonic acid and carbon dioxide;
b. Adding an organic acid binder to the amorphous calcium carbonate solution to promote, nucleation, growth and stabilization of a crystalline aragonite-calcium carbonate and inhibit the formation and concentration of calcite-calcium carbonate;
c. Applying an organic macromolecule to the crystalline aragonite-calcium carbonate.

2. The method according to claim 1, wherein said carbon dioxide and said carbonic acid are present in a ratio of between 2:1 to 15:1.

3. The method according to claim 1, further comprising the steps adding magnesium ion in step b. to further inhibit formation of calcite-calcium carbonate.

4. The method according to claim 1, wherein said inorganic inhibitor is added with molar ratios of magnesium ion to calcium ion ranging from 0.1 to 2.5.

5. The method according to claim 1, wherein said organic binder is added in a concentration of 0.5% to 5% by weight.

6. The method according to claim 1, wherein said organic binder is selected from the groups consisting of amino acids and carboxylic acids.

7. The method of claim 1, wherein divalent cations of calcium are added to bind with double bonded oxygen atoms (carbonyl groups)

8. The method of claim 1, wherein said organic macromolecule is a functionalized cellulose like compound.

9. The method of claim 1, wherein said organic macromolecule is chitin.

10. The method of claim 1, wherein application of said organic macromolecule takes place immediately following formation of said crystalline calcium carbonate.

11. The method of claim 1, wherein said steps a., b., and c. form a first layer.

12. The method of claim 1, further comprising repeating steps a., b., and c., to form successive layers.

13. A composition comprising:
a. A first layer of aragonite calcium carbonate encapsulated in or coated with an organic macromolecule.
b. at least one subsequent layer of aragonite calcium carbonate encapsulated in or coated with an organic macromolecule located adjacent said first layer.
c. A cementitious core substrate for binding and support of the first and subsequent layers of aragonite calcium carbonate, organic binder, and encapsulated macromolecule.

14. A method for the manufacture of synthetic oyster shell material comprising the steps:
a. Preparing solubilized (non-crystalline) amorphous calcium carbonate by mixing a calcium hydroxide with carbonic acid and carbon dioxide;
b. Adding an organic acid binder to the amorphous calcium carbonate solution to promote, nucleation, growth and stabilization of a crystalline aragonite-calcium carbonate and inhibit the formation and concentration of calcite-calcium carbonate to produce a synthesized calcium carbonate composite;
c. Preparing a second crystalline calcium carbonate material, having a range of particle sizes and shapes;
d. Dispersing the second calcium carbonate material and said synthesized calcium carbonate composite to a cementitious substrate and
e. Applying an organic macromolecule to the dispersed said second calcium carbonate material and said synthesized calcium carbonate composite.

15. The method of claim 14, wherein said carbon dioxide and said carbonic acid are present in a ratio of between 2:1 to 15:1 and pressures ranging from 15-500 pounds per square inch.

16. The method of claim 14, further comprising the steps adding magnesium ion in step b. to further inhibit formation of calcite-calcium carbonate

17. The method of claim 14, wherein said inorganic inhibitor is added with molar ratios of magnesium ion to calcium ion ranging from 0.1 to 2.5.

18. The method of claim 14, wherein said organic binder is added in a concentration of 0.5% to 5% by weight.

19. The method of claim 14, wherein said organic binder is selected from the groups consisting of amino acids and carboxylic acids.

20. The method of claim 14, wherein divalent cations of calcium are added to bind with double bonded oxygen atoms (carbonyl groups)

21. The method of claim 14, wherein said organic macromolecule is a functionalized cellulose-like compound.

22. The method of claim 14, wherein said organic macromolecule is chitin.

23. The method of claim 14, wherein application of said organic macromolecule takes place immediately following formation of said crystalline calcium carbonate.

24. The method of claim 14, wherein said steps a., b., c. d. and e. to form a first layer.

25. The method of claim 24, further comprising repeating steps a., b., c, d. and e, to form successive layers over said first layer.
